(19) United States
(12) Patent Application Publication
(10) Pub. No.: US 2026/0092625 A1
(43) Pub. Date: Apr. 2, 2026

(54) MOTION GUIDE APPARATUS

(71) Applicant: THK CO., LTD., Tokyo (JP)

(72) Inventor: Yuki Hayashi, Tokyo (JP)

(73) Assignee: THK CO., LTD., Tokyo (JP)

(21) Appl. No.: 19/113,310

(22) PCT Filed: Sep. 19, 2023
(86) PCT No.: PCT/JP2023/033827

§ 371 Date: Mar. 19, 2025

(30) Foreign Application Priority Data
Sep. 21, 2022 (JP) 2022-149930

(51) Int. Cl. F16C 29/06

(52) U.S. Cl. CPC F16C 29/065; F16C 29/0602

(57) ABSTRACT

Provided is a motion guide apparatus capable of making the movement of rolling elements excellent and improving the durability of a recirculation groove of a block. A motion guide apparatus (1) includes: a rail member (2) including a rolling groove (7); a block (4) including a recirculation groove (5) having a rolling groove (8) facing the rolling groove (7) of the rail member (2), a return groove (9), and a turn groove (10); and a plurality of rolling elements (3) placed in the recirculation groove (5). The rolling elements (3) are picked up, sandwiched between the turn groove (10) of the block (4) and the rolling groove (7) of the rail member (2). A lid member (11) that blocks a part of the turn groove (10) and the return groove (9) is mounted on the block (4).

### TECHNICAL FIELD

The present invention relates to a motion guide apparatus including a rail member and a block.

### BACKGROUND ART

A motion guide apparatus called a linear guide including a rail member and a block is conventionally known. The applicant has proposed a motion guide apparatus in which the block is formed with a recirculation groove including a rolling groove, a return groove, and turn grooves, as a type of motion guide apparatuses (refer to Patent Literature 1). According to this motion guide apparatus, it is possible to recirculate rolling elements by forming the recirculation groove in the block. Therefore, an effect of facilitating the manufacture of the block is exerted.

In the motion guide apparatus described in Patent Literature 1, the rail member is formed with a rolling groove. The block is formed with the recirculation groove including the rolling groove, the return groove, and the turn grooves. A plurality of rolling elements is placed in the recirculation groove. When the block is moved relative to the rail member, the rolling elements roll between the rolling groove of the rail member and the rolling groove of the block. The rolling elements that have rolled between the rolling groove of the rail member and the rolling groove of the block enter the turn groove of the block, move along the turn groove, and then enter the return groove of the block. Subsequently, the rolling elements move along the return groove of the block in a direction opposite to the rolling groove, enter the other turn groove, move along the other turn groove, and then reenter between the rolling groove of the rail member and the rolling groove of the block.

### CITATION LIST

### Patent Literature

Patent Literature 1: WO 2008/038674 A

### SUMMARY OF INVENTION

### Technical Problem

However, the motion guide apparatus described in Patent Literature 1 is structured in such a manner that the block is formed with the recirculation groove and the rolling elements are in contact with the rail member throughout the recirculation groove. As described above, the travel direction of the rolling elements in the return groove is opposite to the travel direction of the rolling elements in the rolling groove. In the return groove, the rolling elements run in the opposite direction to the rail member. Hence, it may become factors in worsening of movement and early deterioration of the recirculation groove.

The reverse running of the rolling elements is described below. Assuming that the block is fixed and the rail member moves, the rolling elements move, rotating, along the rolling groove of the block in the same direction as the rail member. On the other hand, the rolling elements move along the return groove of the block in the opposite direction to the travel direction of the rail member, while being pushed by the succeeding rolling elements. Hence, in the return groove, the rolling elements run in the opposite direction to the rail member. It is to be noted that, in practice, the rail member is fixed and the block moves in many cases. This case can be also similarly considered, taking into account the fact that the block moves relative to the rail member.

The present invention has been made in view of the above problems, and an object of the present invention is to provide a motion guide apparatus capable of making the movement of a rolling element excellent and improving the durability of a recirculation groove of a block.

### Solution to Problem

In order to solve the above problems, one aspect of the present invention is a motion guide apparatus including: a rail member including a rolling groove; a block including a recirculation groove having a rolling groove facing the rolling groove of the rail member, a return groove, and a turn groove; and a plurality of rolling elements placed in the recirculation groove, in which the rolling elements are picked up, sandwiched between the turn groove of the block and the rolling groove of the rail member, and a lid member that blocks a part of the turn groove and the return groove is mounted on the block.

### Advantageous Effects of Invention

According to the one aspect of the present invention, an area in which the rolling elements run in an opposite direction is blocked with the lid member while a portion necessary for recirculation such as a pickup start portion for the rolling elements is left unblocked; therefore, it is possible to make the movement of the rolling elements excellent and improve the durability of the recirculation groove of the block.

### BRIEF DESCRIPTION OF DRAWINGS

FIG. 1 is a perspective view of a motion guide apparatus of one embodiment of the present invention.

FIG. 2 is a front view of the motion guide apparatus of the embodiment.

FIG. 3(a) is a plan view of the motion guide apparatus of the embodiment, and FIG. 3(b) is a side view.

FIG. 4 is an exploded perspective view of a block of the embodiment.

FIG. 5 is a perspective view of a lid member of the embodiment.

FIG. 6 is a diagram illustrating changes in the cross-sectional shape of a turn groove of the block of the embodiment.

FIG. 7 is a schematic diagram of a recirculation groove of the block of the embodiment.

### DESCRIPTION OF EMBODIMENTS

An embodiment of a motion guide apparatus according to the present invention is described in detail hereinafter with reference to the accompanying drawings. However, the motion guide apparatus according to the present invention can be embodied in various forms and is not limited to the embodiment described in the description. The embodiment is provided with the intention of enabling those skilled in the art to fully understand the invention by fully disclosing the description.

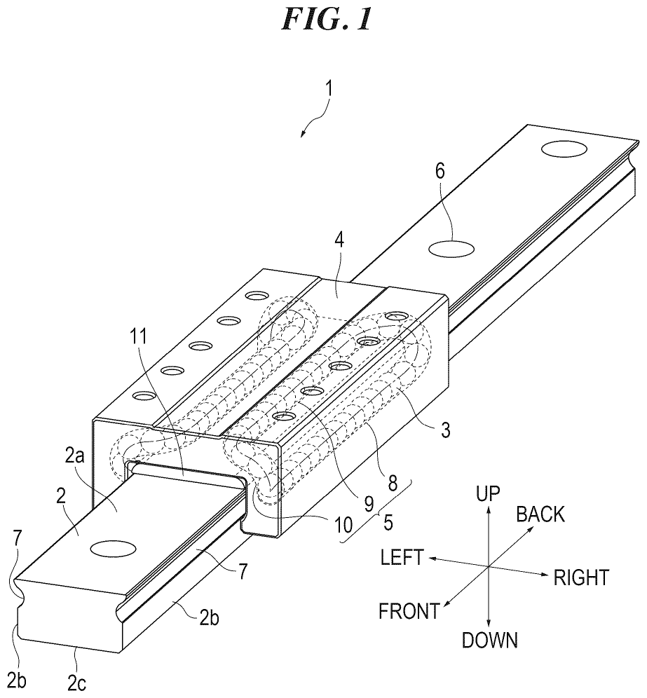

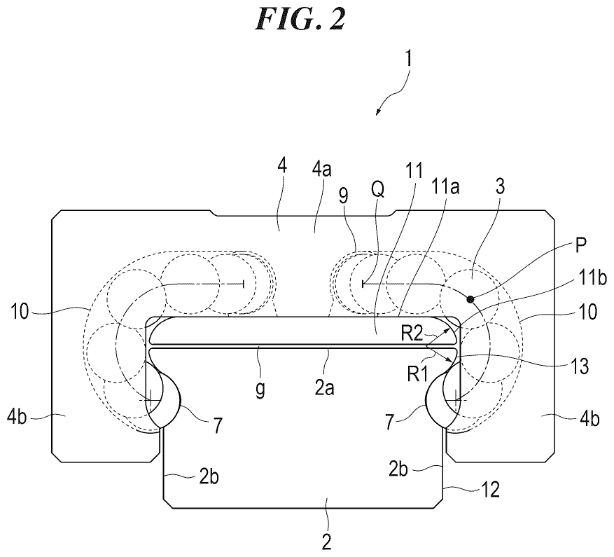

FIG. 1 is a perspective view of a motion guide apparatus 1 of one embodiment of the present invention. FIG. 2 is a front view of the motion guide apparatus 1 of the embodiment.

As illustrated in FIG. 1, the motion guide apparatus 1 of the embodiment is a linear guide including a rail member 2 and a block 4. The rail member 2 is a rail. The block 4 is assembled to the rail member 2 in such a manner as to be movable relative to the rail member 2 in a longitudinal direction. The block 4 is formed with a recirculation groove 5. A plurality of rolling elements 3 such as balls or rollers is placed in the recirculation groove 5.

Note that hereafter, for convenience of description, directions relative to the rail member 2 mounted on a horizontal surface as viewed in the longitudinal direction, that is, directions of up-down, left-right, and front-back in FIG. 1, are used to describe the configuration of the motion guide apparatus 1. Naturally, the placement of the motion guide apparatus 1 is not limited to the above, and the rail member 2 may be mounted on a vertical surface, or the motion guide apparatus 1 may be flipped vertically.

The rail member 2 includes a top surface 2a, a pair of left and right side surfaces 2b, and an undersurface 2c. The side surface 2b of the rail member 2 is formed with a rolling groove 7 along the longitudinal direction. The rolling groove 7 extends linearly. The number of the rolling grooves 7 is, for example, two or four. The top surface 2a of the rail member 2 is formed with a plurality of mounting holes 6 for mounting the rail member 2 on a base.

As illustrated in FIG. 2, the rolling groove 7 is a groove that opens toward the block 4, and its depth is less than the radius of the rolling elements 3. The rolling groove 7 has a Gothic arch shape in cross section. The rolling groove 7 may have a circular arc shape in cross section. A side surface above the rolling groove 7 of the rail member 2 is formed with a protruding portion 13 protruding sideward beyond a lower side surface 12. The protruding portion 13 is continuous with the rolling groove 7 and has an arc shape protruding sideward.

The block 4 has an approximately U shape in cross section and is placed in such a manner as to be astride the rail member 2. The block 4 has a web portion 4a facing the top surface 2a of the rail member 2 and a pair of left and right sleeve portions 4b facing the side surfaces 2b of the rail member 2.

As illustrated in FIG. 1, the block 4 is formed with the recirculation groove 5 including a rolling groove 8, a return groove 9, and turn grooves 10. The block 4 is a single structure. The block 4 may be divided into a central portion formed with the rolling groove 8 and the return groove 9, and end portions formed with the turn grooves 10.

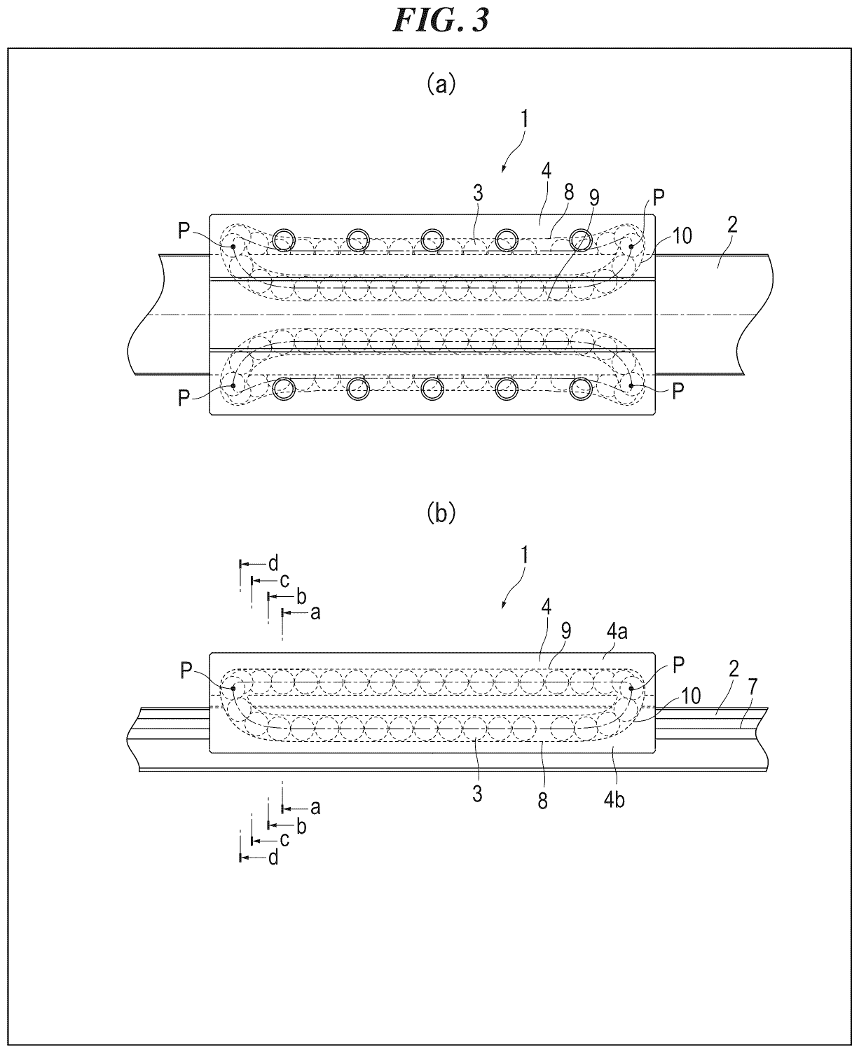

FIG. 3(a) is a plan view of the motion guide apparatus 1 of the embodiment, and FIG. 3(b) is a side view. The sleeve portion 4b of the block 4 is formed with the rolling groove 8 facing the rolling groove 7 of the rail member 2. The rolling groove 8 extends linearly. The web portion 4a of the block 4 is formed with the return groove 9. The return groove 9 is parallel to the rolling groove 8 and extends linearly. The turn grooves 10 are connected to the rolling groove 8 and the return groove 9. The turn grooves 10 have a role in reversing the travel direction of the rolling elements 3. In both the plan view of FIG. 3(a) and the side view of FIG. 3(b), the turn grooves 10 bend, and the turn grooves 10 bend three-dimensionally. Dot-and-dash lines of FIGS. 3(a) and 3(b) indicate the trajectory of the rolling elements 3. The furthest ends in a front-and-back direction, up to which the rolling elements 3 can go, are turn peaks P of the turn grooves 10. The rolling elements 3 reverse their travel direction in the front-and-back direction at each of the turn peaks P.

As illustrated in FIG. 2, each of the turn grooves 10 has, for example, a J-shape being a combination of an arc and a straight line as viewed in the longitudinal direction of the rail member 2. The each of the turn grooves 10 may have a single arc shape.

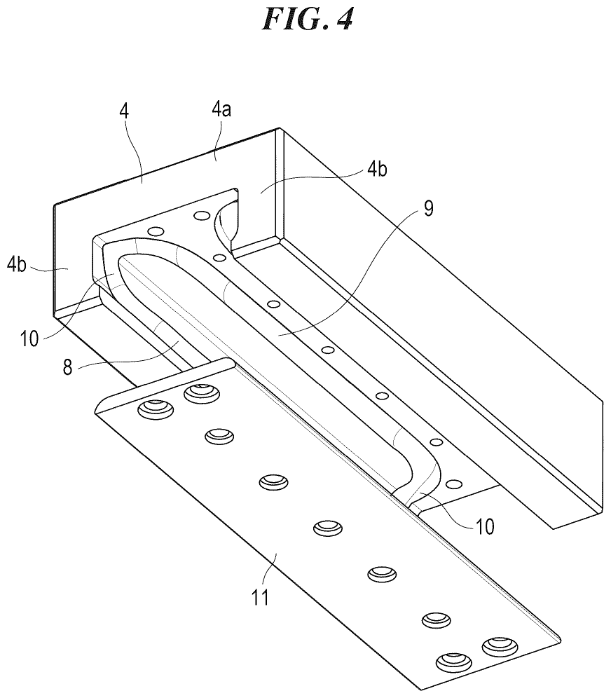

FIG. 4 is an exploded perspective view of the block 4. As described above, the sleeve portion 4b of the block 4 is formed with the rolling groove 8. The rolling groove 8 is a groove that opens toward the rail member 2, and its depth is less than the radius of the rolling elements 3. The rolling groove 8 has a Gothic arch shape in cross section. The rolling groove 8 may have a circular arc shape in cross section.

As described above, the web portion 4a of the block 4 is formed with the return groove 9. The return groove 9 is a groove that opens toward the rail member 2, and its depth is greater than the diameter of the rolling groove 8. A corner portion formed between the sleeve portion 4b and the web portion 4a of the block 4 is formed with the turn grooves 10. The turn grooves 10 are grooves that open toward the rail member 2, and their depth increases gradually from the rolling groove 8 side toward the return groove 9 side.

A lid member 11 is mounted on a lower surface of the web portion 4a of the block 4. The lid member 11 blocks the return groove 9 and also parts of the turn grooves 10. As illustrated in FIG. 2, the lid member 11 is placed between the lower surface of the web portion 4a of the block 4 and the top surface 2a of the rail member 2. A gap g allowing the travel of the lid member 11 relative to the rail member 2 is created between the lid member 11 and the rail member 2.

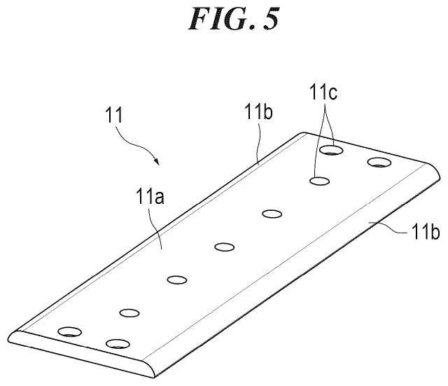

As illustrated in FIG. 5, the lid member 11 has a plate shape. A flat surface 11a is formed on a central portion of a top surface of the lid member 11. A curved surface 11b is formed at a corner portion at each end of the lid member 11 in a width direction thereof. As illustrated in FIG. 2, the lid member 11 blocks at least an area from an end portion Q on the return groove 9 side to the turn peak P of the each of the turn grooves 10 (also refer to FIG. 3(a)). The flat surface 11a of the lid member 11 blocks the return groove 9 and also blocks the straight portions of the turn grooves 10. The curved surfaces 11b of the lid member 11 block the arc-shaped portions of the turn grooves 10.

As illustrated in FIG. 2, each of the curved surfaces 11b of the lid member 11 has an arc shape as viewed in the longitudinal direction of the rail member 2. A radius R2 of the arc of the each of the curved surfaces 11b of the lid member 11 is equal to a radius R1 of the arc of the protruding portion 13 of the rail member 2. R1 and R2 may be different from each other.

As illustrated in FIG. 5, the lid member 11 has a constant cross-sectional shape in the longitudinal direction, and is a single structure. The lid member 11 is formed with a mounting hole 11c for mounting on the block 4. Note that the lid member 11 may be provided with, for example, a positioning pin, a boss, and a positioning hole for positioning on the block 4. Moreover, the lid member 11 may be divided into two or more. The lid member 11 may have, for example, a rectangular shape in cross section, and include portions facing the turn grooves 10, the portions being each formed with a groove having a curved surface.

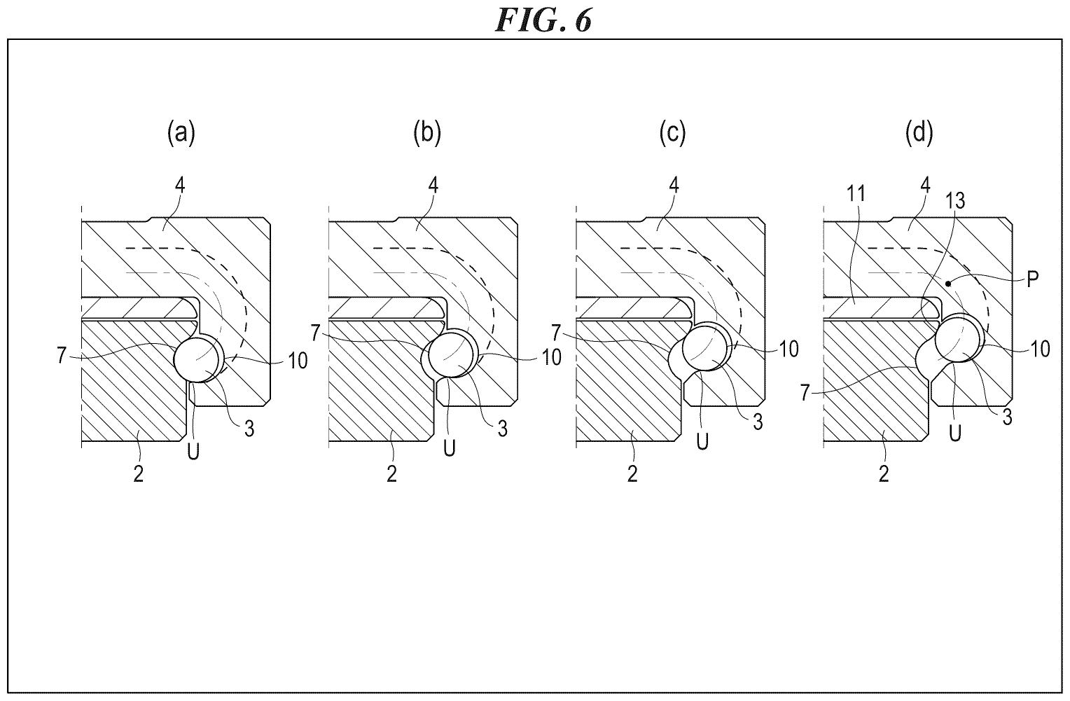

FIG. 6 illustrates changes in the cross-sectional shape of the turn groove 10 of the block 4. FIG. 6(a) is a cross-sectional view taken along line a-a of FIG. 3(b), and illustrates a turn start point of the turn groove 10. FIG. 6(b) is a cross-sectional view taken along line b-b of FIG. 3(b), FIG. 6(c) is a cross-sectional view taken along line c-c of FIG. 3(b), and FIG. 6(d) is a cross-sectional view taken along line d-d of FIG. 3(b).

As illustrated in FIGS. 6(a) to 6(d), the rolling element 3 is picked up, sandwiched between the turn groove 10 and the rolling groove 7 of the rail member 2. In other words, the rolling element 3 that has moved along the rolling groove 8 of the block 4 reaches the turn start point illustrated in FIG. 6(a). As illustrated in FIGS. 6(a) and 6(b), the rolling element 3 that has reached the turn start point is picked up, while being sandwiched between the rolling groove 7 of the rail member 2 and the turn groove 10 of the block 4. In this embodiment, the trajectory of the rolling element 3 is changed upward to the right.

As illustrated in FIGS. 6(b) and 6(c), the rolling element 3 climbs over the rolling groove 7 of the rail member 2, while being sandwiched between the rolling groove 7 of the rail member 2 and the turn groove 10 of the block 4. As illustrated in FIG. 6(d), the rolling element 3 that has climbed over the rolling groove 7 of the rail member 2 moves upward in FIG. 6(d), while being sandwiched between the protruding portion 13 of the rail member 2 and the turn groove 10 of the block 4.

The rolling element 3 that has moved upward of the rail member 2 is released from being sandwiched between the rail member 2 and the block 4. The rolling element 3 enters the turn groove 10 blocked with the lid member 11, pushed by the succeeding rolling element 3.

As illustrated in FIGS. 6(a) to 6(d), the depth of the turn groove 10 increases gradually from the rolling groove 8 side toward the return groove 9 side. The depth of the turn groove 10 is equal to or greater than the diameter of the rolling element 3 at the turn peak P.

As illustrated in FIGS. 6(a) to 6(d), the turn groove 10 is formed with an undercut portion U that reduces the groove width increasingly toward the opening of the turn groove 10. The undercut portion U is a protruding portion formed on a wall surface of the turn groove 10.

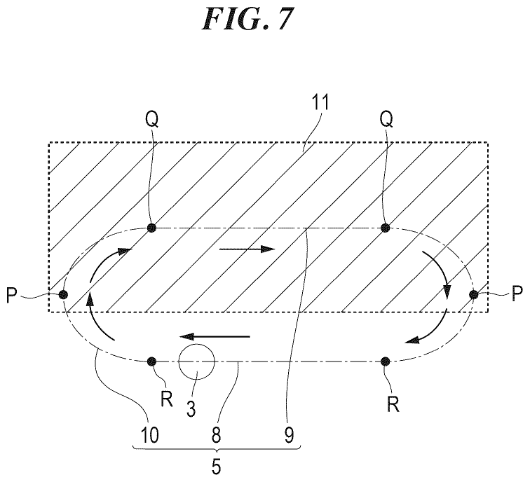

FIG. 7 is a schematic diagram of the recirculation groove 5 of the block 4. The reference numeral 8 denotes the rolling groove, the reference numeral 9 denotes the return groove, and the reference numeral 10 denotes the turn groove. In the rolling groove 8, the rolling element 3 is sandwiched and compressed between the rolling groove 7 of the rail member 2 and the rolling groove 8 of the block 4. Hence, when the block 4 is moved relative to the rail member 2, the rolling element 3 rolls between the rolling groove 7 of the rail member 2 and the rolling groove 8 of the block 4. The rolling element 3 that has moved to one end of the rolling groove 8 of the block 4 enters the turn groove 10 of the block 4.

In the turn groove 10, as described above, the rolling element 3 is picked up, while being sandwiched between the rolling groove 7 of the rail member 2 and the rolling groove 8 of the block 4, climbs over the rolling groove 7 of the rail member 2, and enters the turn groove 10 blocked with the lid member 11. The rolling element 3 that has moved along the turn groove 10 enters the return groove 9 of the block 4, pushed by the succeeding rolling element 3.

In the return groove 9, the rolling element 3 moves in the direction opposite to the travel direction in the rolling groove 8, pushed by the succeeding rolling element 3. The rolling element 3 that has moved along the return groove 9 enters the other turn groove 10, moves along the other turn groove 10, and then reenters between the rolling groove 7 of the rail member 2 and the rolling groove 8 of the block 4.

A hatched portion of FIG. 7 indicates an area in which the lid member 11 blocks the recirculation groove 5. The lid member 11 blocks an area including the return groove 9 and at least from the end portions Q on the return groove 9 side to the turn peaks P of the turn grooves 10. This area is an area in which the rolling element 3 runs in the opposite direction. The area in which the rolling element 3 runs in the opposite direction is blocked with the lid member 11, and thereby it is possible to make the movement of the rolling element 3 excellent and improve the durability of the recirculation groove 5 of the block 4.

On the other hand, the lid member 11 does not block pickup start portions for the rolling element 3 (the vicinities of end portions R on the rolling groove 8 sides of the turn grooves 10). This is because, in the pickup start portions for the rolling element 3, the travel direction of the rolling element 3 agrees with the relative moving direction of the rail member 2, and the rail member 2 assists the recirculation of the rolling element 3.

Up to this point, the configuration and effects of the motion guide apparatus 1 of the embodiment have been described. The motion guide apparatus 1 of the embodiment has the following effects:

The lid member 11 is formed with the curved surfaces 11b that block parts of the turn grooves 10. Therefore, the lid member 11 can block the turn grooves 10 that bend three-dimensionally.

Each of the turn grooves 10 is formed with the undercut portion U that reduces the groove width increasingly toward the opening of the turn groove 10. Therefore, the play of the rolling elements 3 onto an inner peripheral side of the each of the turn grooves 10 is reduced, and the rolling elements 3 move smoothly along the turn grooves 10. More specifically, as illustrated in FIG. 2, the gap g is present between the lid member 11 and the rail member 2 on the inner peripheral side of the each of the turn grooves 10. The each of the turn grooves 10 is formed with the undercut portion U. Therefore, the amount of play of the rolling elements 3 onto the inner peripheral side of the each of the turn grooves 10 is reduced, and the rolling elements 3 are pressed against an outer peripheral side of the each of the turn grooves 10 due to centrifugal force. Hence, it is possible to prevent the rolling elements 3 from moving along the gap g on the inner peripheral sides of the turn grooves 10.

The lid member 11 is mounted on the lower surface of the web portion 4a of the block 4. Therefore, the area in which the rolling elements 3 run in the opposite direction can be effectively blocked.

The lid member 11 has a plate shape. Therefore, the lid member 11 can be easily manufactured.

It is to be noted that the present invention is not limited to concretization of the above embodiment, and can be concretized in other embodiments within the scope that does not change the purport of the present invention.

In the above embodiment, the example of a full rolling element type has been described. However, a spacer may be interposed between the rolling elements.

In the above embodiment, the example of the outer block type linear guide in which the block having an approximately U shape in cross section is astride the rail member has been described. However, an inner block type linear guide may be used in which an inner block is placed in an outer rail having an approximately U shape in cross section.

In the above embodiment, the example in which the motion guide apparatus is a linear guide has been described. However, the motion guide apparatus may be a ball spline.

The present description is based on Japanese Patent Application No. 2022-149930 filed on Sep. 21, 2022. The entire contents thereof are incorporated herein.

### REFERENCE SIGNS LIST

1 Motion guide apparatus
2 Rail member
3 Rolling element
4 Block
4a Web portion
4b Sleeve portion
5 Recirculation groove
7 Rolling groove of the rail member
8 Rolling groove of the block
9 Return groove
10 Turn groove
11 Lid member
11b Curved surface of the lid member
P Turn peak
Q End portion on a return groove side of the turn groove
R End portion on a rolling groove side of the turn groove
U Undercut portion

1. A motion guide apparatus comprising:
a rail member including a rolling groove;
a block including a recirculation groove having a rolling groove facing the rolling groove of the rail member, a return groove, and a turn groove; and
a plurality of rolling elements placed in the recirculation groove, wherein
the rolling elements are picked up, sandwiched between the turn groove of the block and the rolling groove of the rail member, and
a lid member that blocks a part of the turn groove and the return groove is mounted on the block.

2. The motion guide apparatus according to claim 1, wherein the lid member blocks at least an area from an end portion on a return groove side to a turn peak of the turn groove.

3. The motion guide apparatus according to claim 1 wherein the lid member is formed with a curved surface that is curved as viewed in a longitudinal direction of the rail member and blocks a part of the turn groove.

4. The motion guide apparatus according to claim 1 or 2, wherein the turn groove is formed with an undercut portion that reduces a groove width increasingly toward an opening of the turn groove.

5. The motion guide apparatus according to claim 1 wherein
the block includes a web portion facing a top surface of the rail member, the web portion being formed with the return groove, and a sleeve portion facing a side surface of the rail member, the sleeve portion being formed with the rolling groove, and
the lid member is mounted on a lower surface of the web portion.

6. The motion guide apparatus according to claim 5, wherein the lid member has a plate shape.

7. The motion guide apparatus according to claim 2, wherein the lid member is formed with a curved surface that is curved as viewed in a longitudinal direction of the rail member and blocks a part of the turn groove.

8. The motion guide apparatus according to claim 2, wherein the turn groove is formed with an undercut portion that reduces a groove width increasingly toward an opening of the turn groove.

9. The motion guide apparatus according to claim 2, wherein
the block includes a web portion facing a top surface of the rail member, the web portion being formed with the return groove, and a sleeve portion facing a side surface of the rail member, the sleeve portion being formed with the rolling groove, and
the lid member is mounted on a lower surface of the web portion.
